(19) United States
(12) Patent Application Publication
(10) Pub. No.: US 2021/0035089 A1
(43) Pub. Date: Feb. 4, 2021

(54) TIERED ACCESS TO DOCUMENTS IN A DIGITAL WALLET

(71) Applicant: HRB Innovations, Inc., Las Vegas, NV (US)

(72) Inventor: Joel F. Johnston, Topeka, KS (US)

(21) Appl. No.: 16/525,873

(22) Filed: Jul. 30, 2019

(51) Int. Cl. G06Q 20/36; G06Q 20/38

(52) U.S. Cl. CPC G06Q 20/363; G06Q 20/3821; G06Q 20/383

(57) ABSTRACT

A digital wallet system comprises a document originator server and a user device. The document originator server is configured to generate a subject document including a first portion and associate an authentication stamp to form a document package. The document originator server is further configured to send the document package to a user. The user device corresponds to the user. The user device is configured to receive the document package and store the document package in a digital wallet. The user device is further configured to receive, from the user, a request to access the subject document, as well as a credential indication. The user device will provide, to the user, access to only said first portion of the subject document based upon a credential level of the credential indication.

### BACKGROUND

### 1. Field

Embodiments of the invention relate to digital wallets. More specifically, embodiments of the invention provide tiered access to information stored within a digital wallet.

### 2. Related Art

Digital wallets, which may also be referred to as virtual wallets, are typically used to facilitate financial transactions. A typical digital wallet will include sensitive information for a potential financial transaction. For example, the digital wallet may include credit card information, bank account information, or similar information stored locally on a smartphone or other user device. The information is secured in the digital wallet until needed for a financial transaction. During the transaction, the information is transferred to the merchant to facilitate the transaction.

### SUMMARY

Embodiments of the invention provide additional benefits to a digital wallet that are not available under existing systems. Embodiments of the invention utilize a digital wallet to store sensitive documents within a digital wallet and allow tiered access to the documents. The tiered access allows the user to access or transfer the document based upon credentials provided by the user to the user device. This allows for the secure storage of sensitive documents on a user device, such that the user may access and/or transfer the documents as needed.

A first embodiment of the invention is directed to a digital wallet system. The digital wallet system comprises a document originator server and a user device. The document originator server is configured to generate a subject document including a first portion and associate an authentication stamp to form a document package. The document originator server is further configured to send the document package to a user. The user device corresponds to the user. The user device is configured to receive the document package and store the document package in a digital wallet. The user device is further configured to receive, from the user, a request to access the document, as well as a credential indication. The user device will provide, to the user, access to only said first portion of the document based upon a credential level of the credential indication.

A second embodiment of the invention is directed to a non-transitory computer readable storage medium having a computer programmed stored thereon for providing access to documents on a digital wallet, wherein upon execution by at least one processing element, instructs at least one processing element to perform the following steps: receiving a document package, wherein the document package includes a subject document having a first portion and an authentication stamp; storing the document package in the digital wallet; receiving, from the user, a request to access the subject document; receiving, from the user, a credential indication; and providing, to the user, access to only said first portion of the subject document based upon a credential level of the credential indication.

A third embodiment of the invention is directed to a computerized method of managing sensitive documents in a digital wallet, the method comprising the following steps: receiving a document package, wherein the document package includes a subject document having a first portion and an authentication stamp; storing the document package in the digital wallet; receiving, from the user, a request to access the subject document; receiving, from the user, a credential indication; and providing, to the user, access to only said first portion of the subject document based upon a credential level of the credential indication.

Still other embodiments of the invention may be directed to a computerized method of implementing the steps discussed herein. Still other embodiments of the invention may be directed to a system that comprises a server and a user device. The server is configured to receive information from the user device to implement the discussed steps. Still other embodiments of the invention may be directed to a third party server configured to perform the discussed steps.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 is a flow diagram of an exemplary embodiment of the invention that stores documents in and provides access to a digital wallet;

FIG. 2 is a flow diagram illustrating more detailed steps performed by a document originator;

FIG. 3 is a flow diagram illustrated more detailed steps performed by the digital wallet; and

FIG. 4 is a system diagram of an embodiment of the invention depicting various computing devices and their components.

The drawing figures do not limit embodiments the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, embodiments of the invention can include a variety of combinations and/or integrations of the embodiments described herein.

Embodiments of the invention may be directed to a system, a computerized method, or a computer program for a digital wallet offering tiered authentication and access to individual documents. Embodiments of the invention utilize a digital wallet to store sensitive documents within a digital wallet and allow tiered access to the documents. The tiered access allows the user to access or transfer the document based upon credentials provided by the user to the user device. This allows for the secure storage of sensitive documents on a user device, such that the user may access and/or transfer the documents as needed.

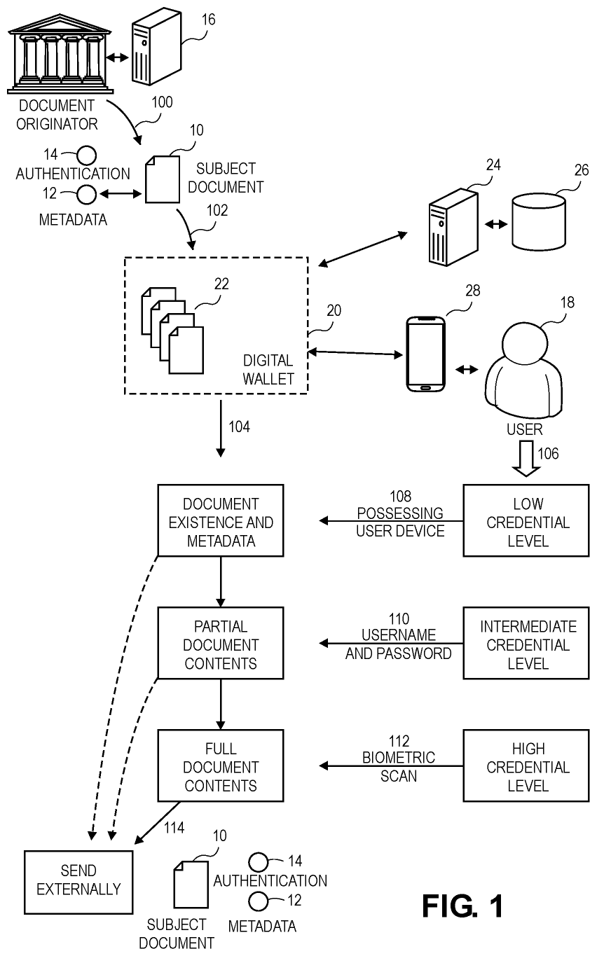

FIG. 1 depicts an exemplary embodiment of the invention. In FIG. 1, a document is generated, sent to a digital wallet, and later accessed and/or transferred to some external entity. More specifically, the document is configured to allowed tiered access based upon a credential level of the user. The credential level dictates what information about or portions of the document to provide access to the user, and whether the document may be transferred externally.

In Step 100, a subject document 10, which may include a set of metadata 12 and an authentication stamp 14, is created by a document originator server 16. The subject document 10 may be any of numerous types of documents, as discussed below. For example, the subject document 10 may be a business record, a medical record, a tax document, or other document. The subject document 10 may include a set of metadata 12. For example, the set of metadata 12 may include information about the subject document 10, the origin of the subject document 10, the contents of the subject document 10, the type of document, the person or organization that is the recipient of the subject document 10, the person or organization that is otherwise associated with the subject document 10, and other information. The subject document 10 may also include an authentication stamp 14. The authentication stamp 14 marks the subject document 10 as authentic. The authentication stamp 14 may include a key or other information with which the recipient or other external entity may validate the authenticity of the subject document 10.

In some instances, the subject document 10 is generated during a normal course of business (such as a business record or a medical record). In these instances, the subject document 10 may be retrieved or identified in Step 100. For example, the subject document 10 may be identified after being specifically requested by the recipient or other person. In other instances, the subject document 10 is generated for a specific purpose (such as a tax document). In these instances, the subject document 10 may be automatically sent upon generation.

In some embodiments, the subject document 10, the set of metadata 12, and the authentication stamp 14 may be referred to collectively as a document package. The document package is sent as a package such that additional information and authentication information accompany the subject document 10. The document package may be sent, stored, and transferred as a unit. It should be appreciated that, as used herein, the subject document 10 may refer to the document package.

In Step 102, the subject document 10 is sent to a user 18 by the document originator server 16. In many instances, the user 18 will be the recipient (e.g., the subject of the subject document 10). In other instances, the user 18 will be another person authorized to receive the subject document 10. For example, an employer may receive a report regarding the activities of an employee.

More specifically, in Step 102 the subject document 10 is sent to a digital wallet 20 associated with the user 18. The digital wallet 20 may include a set of other documents 22. The digital wallet 20 may store the subject document 10 and the set of other documents 22 electronically such that they may be accessed or transferred in the future. The digital wallet 20 may be encrypted or otherwise secured to prevent

A digital wallet 20 is a software and/or hardware component. The digital wallet 20 provides security and encryption for the personal information and for a transaction. Typically, digital wallets are stored locally and are easily self-maintained. A server-side digital wallet, also known as a thin wallet, is one that an organization creates and keeps on its own server. Server-side digital wallets are gaining popularity among major retailers due to the security, efficiency, and added utility it provides to the end-user. The digital wallet may also comprise database of user-input information and preferences. This information stored in the wallet may include a shipping address, billing address, payment methods (including credit card numbers, expiry dates, and security numbers), and other information for a transaction.

The digital wallet 20 may be associated with a wallet server 24 and/or a wallet datastore 26. Additionally or alternatively, the digital wallet 20 may be associated with a user device 28. The digital wallet 20 may be typically on a smartphone, tablet, or other user device 28. The digital wallet 20 may also be a dedicated digital wallet such as a biometric wallet, which is a physical device that holds cash and cards along with a BLUETOOTH mobile connection, NFC, mobile broadband, Wi-Fi, or via some other electronic connection method.

In Step 104, the digital wallet 20 receives an access request from the user 18. The access request may be a request to display the subject document 10, transfer the subject document 10, or perform some other task in relation to the subject document 10. For example, if the subject document 10 is a medical record, the subject document 10 may have been transferred to the user's digital wallet 20 upon the user 18 being referred to a specialist medical provider. When the user 18 arrives at the specialist medical provider, the user 18 requests access to the medical record from the digital wallet 20 of the user 18. As another example, if the subject document 10 is a tax document (e.g., a record with tax implications), the subject document 10 may have been transferred to the user's digital wallet 20 upon creation of the subject document 10. Then, when the user 18 is ready to prepare a tax return, as discussed more below, the user 18 arrives at a tax professional location. The user 18 will then request to access the subject document 10 such that the subject document 10 may be transferred to the tax professional, observed on the user device 28, be printed, or other task be performed in relation to the subject document 10.

In many instances, the request will be received via the user device 28 regardless of whether subject document is stored on the user device 28, at the wallet server 24, at the wallet datastore 26, or at some other location. The user 18 is directly interacting with the user device 28 (such as a smartphone or personal computer, as discussed below). Thus, the request is received at the user device 28. The other steps discussed may be performed locally at the user device 28, at the wallet server 24, at another cloud server, at a server associated with the document originator server 16, or other computing device.

In Step 106, the user device 28 receives a credential indication from the user 18. Depending on the type, level, veracity, confidence, or other criteria of the credential indication, the user 18 will be granted a tiered level of access to the subject document 10. Various exemplary tiers of access are discussed below. In many instances, the subject document 10 is a highly sensitive document. As such, the standard authentication may not be practical or secure. As discussed above, in prior systems authentication is a binary consideration. The user 18 is either authenticated or the user 18 is not, and thus the user 18 is either entitled to access the subject document 10 or the user 18 is not. The tiered authentication can provide the user 18 to access with enough information as needed for the situation, without requiring excessive authentication when not needed for the situation.

The credential indication may be any type of indication that the current user 18 of the device is the recipient of the subject document 10, the controller of the digital wallet 20, or is otherwise duly authorized to access the subject document 10. For example, the credential indication could be a pin number for the user device 28, a pin number for the digital wallet 20, a password for the user device 28, a password for the digital wallet 20, a username and password for the user device 28, a username and password for the digital wallet 20, a two-factor authentication, a biometric scan, a facial photographic recognition, or other authentication information.

In embodiments of the invention, the credential information may be received specifically in response to a request from the user device 28. In other embodiments, the credential information may be received at the user device 28 prior to the request being made by the user 18. For example, the user 18 may unlock the user device 28 and then make the request. The credential information may be requested at a certain level based upon the request received. If the user 18 sends a specific request, the user device 28 may inform the user 18 of the credential level that must be met or exceeded to fulfill that request. If the user request can already be fulfilled with the credential level already provided by the user 18 (such as in accessing the user device 28 or provided for a previous accessing), no additional request may be made of the user 18.

In Step 108, upon a low credential level being received from the user 18, minimal information related to the subject document 10 is provided to the user 18. In the example of FIG. 1, the low credential level is the user 18 possessing and having access to the user device 28. Further, the minimal information is an indication of the existence of the subject document 10 and at least a portion of the metadata 12 associated with the subject document 10. It should be appreciated that other information may constitute a low credential level, and other levels of access may be granted to the subject document 10 based upon the low credential level.

For example, if the subject document 10 is a tax document, the user 18 may be presented with information that the tax document exists, the type of document (such as a W2), the document originator (such as an employer name of the user 18), and the date. This will allow the user 18 to know what documents 22 are present in the digital wallet 20 without having access to the full contents of those documents 22. The user 18 may wish to review what documents 22 are in the digital wallet 20 before visiting a tax professional, for example, such that the user 18 knows that the user 18 is bringing all necessary documents 22 to the tax professional. In order to know that all needed documents 22 are present, the user 18 does not need access to the documents 22, so a lower credential level will suffice for this purpose.

In Step 110, upon an intermediate credential level being received from the user 18, intermediate information related to the subject document 10 is provided to the user 18. In the example of FIG. 1, the intermediate credential level is the user 18 providing a user 18 name and password. Further, the intermediate information is partial contents of the subject document 10. It should be appreciated that other information may constitute an intermediate credential level, and other levels of access may be granted to the subject document 10 based upon the intermediate credential level. Also, there may be a plurality of intermediate credential levels with a corresponding plurality of intermediate information levels.

To continue the example of the tax document provided above, the user 18 may be presented with partial contents of the tax document. If the tax document is a W2, the user 18 may be presented with the gross pay amount and other partially sensitive information. The highly sensitive information, such as the social security number, may be redacted or otherwise not displayed to the user 18. The user 18 may only need to know a portion of the information on the subject document 10; thus, the intermediate level of access may suffice for that purpose. For example, the user 18 may be asked for their gross income level in the intermediate year. The user 18 may then access just that information from their digital wallet 20 without providing a high enough credential level for access to the entire document. This improves the user experience and provides a solution to a computer-specific problem. In order to know a portion of the information on the subject document 10, the user 18 does not need full access to the set of documents 22, so an intermediate credential level will suffice for this purpose.

In Step 112, upon a high credential level being received from the user 18, full information related to the subject document 10 (such as the entirety of the subject document 10, the entirety of the set of metadata 12, etc.) is provided to the user 18. In the example of FIG. 1, the high credential level is the user 18 providing a biometric scan. Further, the full information is the full contents of the subject document 10 (which may include the complete set of metadata 12). It should be appreciated that other information may constitute an intermediate credential level, and other levels of access may be granted to the subject document 10 based upon the intermediate credential level. For example, the user 18 may provide two-factor authentication or other heightened credential indication.

To continue the example of the tax document provided above, the user 18 may be presented with the entire tax document. The tax professional preparing the tax return may need to see the entirety of the tax document such that the tax professional can verify the veracity of the tax document and then sign the tax return. Thus, the user 18 may provide the high credential level such that the complete tax document may be accessed from the user device 28, transferred to the tax professional or other task is performed.

In Step 114, the portions of the subject document 10 accessed above may be sent externally from the digital wallet 20 to some external entity. The information may be transferred via NFC, BLUETOOTH, mobile broadband, Wi-Fi, or via some other electronic method. In some embodiments, the document package, including the subject document 10, the set of metadata 12, and the authentication stamp 14, may be sent to the external entity. In other embodiments, a modified document package may be sent, which includes only a portion of the set of metadata 12, only a portion of the subject document 10, only a portion of the authentication stamp 14, or some combination thereof. In some embodiments the modified document package may include only those portions of the subject document 10 that were accessed in Steps 108, 110, or 112. In other embodiments, the modified document package may include additional metadata 12 and/or additional authentication stamps 14 indicative of the digital wallet 20, and/or the user 18 associated with the digital wallet 20.

The external entity may then utilize the subject document 10 and/or the information therein to perform any of numerous tasks. For example, a medical facility may review the medical records and treat a patient accordingly. As another example, a tax professional may review the tax documents to prepare a tax return. The external entity may also verify the authenticity of the subject document 10 via the authentication stamp 14. In some embodiments, the authentication stamp 14 may be self-evident, such as associated with a blockchain. In other embodiments, the authentication stamp 14 may be compared or analyzed with a key specific to the external entity. In still other embodiments, the external entity may request authentication directly from the document originator server 16 via a key or other information in the authentication stamp 14.

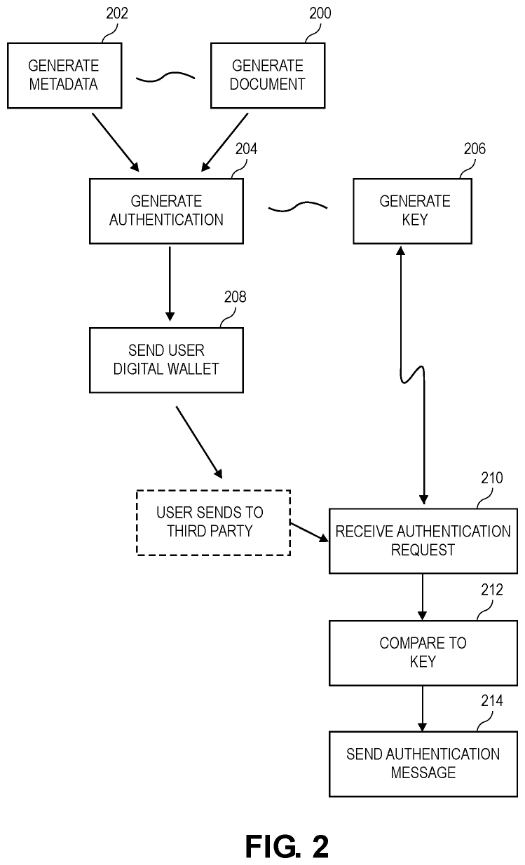

Turning to FIG. 2, exemplary steps performed by the document originator are shown. The document originator is the source which creates, distributes, or holds the subject document 10. In some embodiments, the document originator receives a portion of the subject document 10, at least a portion of the information on the subject document 10, or the entire document from external programs, applications, parties, or other sources. In other embodiments, the subject document 10 is fully generated at the document originator based upon information available to the document originator. The document originator may control, utilize, instruct, or otherwise be associated with the document originator server 16.

Examples of document originators may include a natural person, a business entity, a non-profit organization, a governmental agency, or other organization. In some embodiments, the document originator may be a separate service that is configured to authenticate and package documents for digital wallets. In these embodiments, at least a portion of the steps discussed herein may be performed as a service for other parties.

In Step 200, the document originator server 16 generates the subject document 10. The subject document 10 may be generated from information known to or accessible by the document originator server 16. For example, if the document originator is a medical facility, the subject document 10 may be generated by compiling medical records created locally. As another example, if the document originator is an employer, the subject document 10 may be a record of payments made to an employee. In other embodiments, the subject document 10 is at least partially received from an external party.

The subject document 10 may be a certain format, be a completion of a certain form, or have some other standardized layout. This format, form, or layout will allow certain portions of the subject document 10 to be redacted or excluded, such as in Steps 108 and 110 discussed above. In other embodiments, the subject document 10 may be analyzed to determine which portions, if any, contain varying levels of sensitive information.

The subject document 10 may include various levels of sensitive information thereon. For example, the document may include public information, sensitive information, and highly confidential information. The determination of what information is public, sensitive, or highly confidential (or of another level) may be determined based upon the format, form, or layout of the subject document 10. Any section of the subject document 10 may be referred to as a first portion, a second portion, etc.

In Step 202, the document originator server 16 generates a set of metadata 12. Metadata associates one set of data with another set of data. The metadata may be embedded in the subject document 10, stored externally in a separate file that is associated with the subject document 10, otherwise associated with the subject document 10, or all of the above. Embedding the metadata into the same file with the subject document 10 can be advantageous because it allows the metadata to travel as part of the data it describes. In some such embodiments, metadata is associated with a section or field of the subject document 10. Specifically, a first portion of the subject document 10 may be a field that is filled with certain information. This is advantageous where, for example, the same subject document contains more than one sections or fields each with independent properties or information. In other such embodiments, the metadata is associated with the subject document 10 file as a whole. Externally stored metadata may also have advantages, such as ease of searching and indexing. The metadata may also be stored in a human-readable format, such that an operator can access and understand the metadata without any special software. The metadata may also be encrypted and locked such that a malfeasant cannot change the metadata associated with the subject document 10.

In some embodiments, at least a portion of the set of metadata 12 is indicative of the sensitivity level of the information on various portions of the subject document 10. For example, the set of metadata 12 may include an indication of the various subdivisions of the subject document 10 with a corresponding sensitivity level for each. Alternatively, this information may be on the subject document 10 itself. Thus, a first portion of the subject document 10 may have a lower sensitivity level than a remainder of the subject document 10 (e.g., in comparison to information in a second portion of the subject document).

In Step 204, the document originator server 16 generates an authentication stamp 14. The authentication stamp 14 may be any of numerous authentication techniques for ensuring that a set of data remains secured and accurate. In Step 206, the document originator server 16 generates a key or other information associated with the authentication stamp 14. The key may be utilized by the user 18, an external party, or others in authenticating that the subject document 10 is in fact a true and accurate copy of the original subject document prepared or organized by the document originator.

In Step 208, the document originator server 16 sends the document package to the digital wallet 20 of the user 18. The document package may be sent directly to the user device 28, the wallet server 24, or the wallet datastore 26. In some embodiments, the document package may be sent to the wallet server 24, which will save a copy of the document package in the wallet datastore 26 and save a copy of the document package in the user device 28. In other embodiments, the document package may be directly to the wallet server 24, which will then forward the subject document 10 to the digital wallet 20 on the user device 28 without retaining a copy of the subject document 10.

The user 18 may then send the document package, or a portion thereof, to an external party. The user 18 may do so by requesting access to the subject document 10 via the digital wallet 20 or otherwise via the user device 28. This step is discussed below. Examples of an external party may be similar to the above examples of the document originator. The external party may be a business facilitating a transaction, a medical facility utilizing the medical records, a tax professional utilizing the tax documents, or other person or entity. Specifically, the document package, or a portion thereof, may be sent to a server associated with the external party, a computing device associated with the external party, to an independent server and designated for the external party, or in another way made available to the external party.

In Step 210, the document originator server 16 receives (either directly or indirectly) a request for authentication from the external party. In embodiments, this will include the external party sending a key, or other information related to the document package, to the document originator server 16 to request the authentication. In other embodiments, the document originator server 16 receives a request for authentication from the external party via the digital wallet 20. In these embodiments, the external party may request the authentication from the digital wallet 20 because the digital wallet 20 is already in communication with the external third party. This request may be forwarded, sent, or otherwise indicated to the document originator server 16. The request may include information about the external third party such that the authentication may be performed directly between the external third party and the document originator. In other embodiments, the information regarding how to authenticate may be included in the set of metadata 12 and/or or the authentication stamp 14.

In Step 212, the document originator server 16 compares the key, or other information, provided by the external party so as to authenticate the subject document 10. This step may be performed to ensure a secure transfer between the document originator server 16 to the external party via the digital wallet 20. Because the digital wallet 20 is generally secure, but typically not under the control of either the document originator or the external party, this verification step may ensure that information received at the external party is accurate and secure.

In Step 214, the document originator server 16 sends an authentication message to the external party. In some embodiments, this may be a written confirmation that the subject document 10 is authentic. In other embodiments, this may be a key to decrypt the subject document 10. In still other embodiments, this may be a confirmation that the information on the subject document 10 matches the information available to the document originator.

Similar steps may be performed by the external third party and are not specifically illustrated. Specifically, the external third part may receive the subject document 10 from the digital wallet 20. The external party may then analyze the subject document 10 to determine what, if any, authentication information is present. For example, the external party may determine whether the subject document 10 includes an authentication stamp 14 that is self-evident or whether the subject document 10 includes a key for authentication. The external party will then request the authentication from the document originator server 16 (if applicable). The external party will receive the authentication message from the document originator server 16.

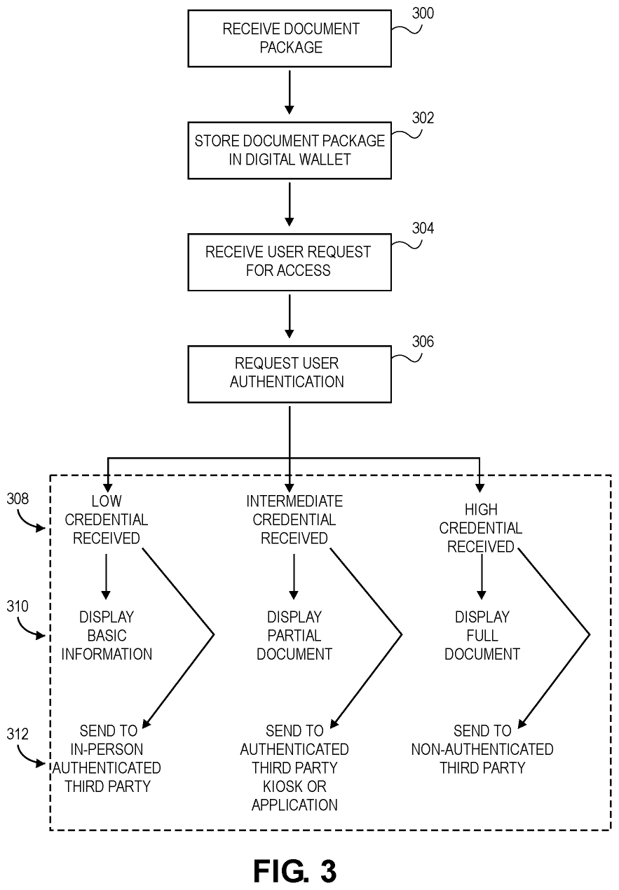

Turning to FIG. 3, exemplary steps performed by the digital wallet 20 are shown. As discussed above, the digital wallet 20 may include software and/or hardware components. The digital wallet 20 may be a component of the user device 28, may be stored remotely from the user device 28, or some combination thereof. The digital wallet 20 interfaces with the user 18. The digital wallet 20 may include a graphical user interface or may be accessible from a graphical user interface otherwise on the user device 28. The digital wallet 20 may be a native application of the user device 28, a downloaded application on the user device 28, or otherwise transferred to the user device 28 by the user 18 or other person.

In Step 300, the digital wallet 20 receives the document package. The digital wallet 20 may receive the document package from a wallet server 24, directly from the document originator server 16, directly from another user device 28 also associated with the user 18, or from some other source. In some embodiments, the digital wallet 20 may receive only a portion of the document package. For example, the entirety of the document package may be stored in the wallet datastore 26 associated with the wallet server 24, with only a set of metadata 12 and/or a portion of the subject document 10 stored in the digital wallet 20. In Step 302, the digital wallet 20 stores the document package. The digital wallet 20 may encrypt or otherwise secure the document package (or the portion thereof) within the digital wallet 20 for security.

In Step 304, the digital wallet 20 receives a request from the user 18 to access the subject document 10. The request may be via a selection on the user device 28, an electronic signal indicative of the request being made on the user device 28, or other indication. The request may also be received from a third party system. For example, if the user 18 is at a tax professional, the tax professional may request the subject document 10 from the digital wallet 20 of the user 18 directly.

In some embodiments, the request may be a generic request for the subject document 10. In these embodiments, the request may be processed according to the credential level of the user 18 already entered (if any) and then the user 18 is presented with an option to display more of the subject document 10 (or more information related to the subject document 10) upon an increase in the credential level. This may include specific credential level requirements for specific information on or about the subject document 10. For example, the user 18 may request access to a W2 in their digital wallet 20. By default, the user 18 is presented with information about the W2 (such as the year and the document originator) without being shown any information on the W2. The digital wallet 20 may then present the user 18 with an option to show more of the information on the W2. To continue this example, the digital wallet 20 may present a message such as “To view the general payee information and the gross payment information, please enter your digital wallet password. to view the entire document, please enter a biometric scan.” The user 18 is presented with options to select either of those choices, or to directly enter the required credential indication (e.g., the user 18 may utilize a biometric scanner associated with the user device 28 without otherwise selecting an option from the graphical user interface).

In Step 306, the digital wallet 20 requests credential information from the user 18. This may include presenting, to the user 18 via the graphical user interface, a request for a specific credential. In some embodiments, the credential information may be requested only if the requested access level exceeds the current credential level. If the current credential level meets or exceeds the requested access level, the access may be granted automatically.

In Step 308, the digital wallet 20 receives the credential information from the user 18. The credential information may be received directly at the user device 28. For example, the user 18 may input a username and password into the user device 28. As another example, the user 18 may utilize a biometric scanner of the user device 28). Additionally or alternatively, the credential information may be received indirectly from another device. For example, the user 18 may perform a biometric scan on a biometric scanner that is external to the user device 28. As another example, at least a portion of the credential information may be received via two factor authentication utilizing a second user device 28.

The credential level can be expressed in any of several forms. A first exemplary form is a numerical value. The numerical value could be expressed as a general level (such as the low, intermediate, and high shown in FIG. 3), a tier (such, first tier, second tier, third tier, etc.), or other designation. In other embodiments, the numerical value could be expressed as a level from 0-10, such that 0 is no credentials and 10 is definitely credentialed (intermediate values ranging from 0.1 to 9.9 or 1 to 9). In yet other embodiments, the numerical value is a summation of factors with no theoretical maximum or theoretical minimum. A second exemplary form is a letter grade, such as an “F” for definitely no access will be granted and an “A” for definitely access will be granted (intermediate values being “B,” “C,” and “D”—possibly including plusses and minuses). A third exemplary form may be a color system in which red is definitely not verified and green is definitely verified (intermediate values being on the color spectrum between red and green). A fourth exemplary form may be a simple pass/fail designation. The pass/fail designation definitely states whether the system believes the current user 18 of the user device 28 is an authorized user for that needed access level. In this and other forms, the system may presume that the user 18 is not verified until the user 18 proves the user's authenticity. A fifth exemplary form may be a threshold illustration. For example, the threshold illustration may be a thermometer with the level of the thermometer approximating the authenticity level and an illustrated threshold above which the user 18 must move the level before being allowed to access the subject document 10 as desired.

In Step 310, the digital wallet 20 provides local access to the subject document 10 in accordance with the level of authentication provided by the user 18. Local access is the presentation of the contents, or a portion thereof, of the subject document 10 on the display of the user device 28. The amount of local access is granted based upon the credential level, as discussed above regarding FIG. 1.

In Step 312, the digital wallet 20 transfers the subject document 10 (or a portion thereof) to an external party. In some embodiments, the credential level is determinative of what types of third parties may be transferred the subject document 10. It should be appreciated that in many instances the user 18 will request access only for the local access or transfer of the subject document 10. However, in some instances the user 18 will request local access as well as a transfer. The amount of the subject document 10 transferred may be determined by the local access level of that credential level or may be independent thereof. For example, the transfer may be performed always on the complete document, or the transfer may be on as much of the subject document 10 as was authorized for local access.

As a first example, as shown in FIG. 3, a user 18 having a low credential level may nonetheless be permitted to transfer the subject document 10 to an in-person authenticated third party. An example of this may be an in-person medical facility or an in-person tax professional. In this case, the in-person authenticated third party may be able to receive the subject document 10 (e.g., the digital wallet 20 may authorize the transfer) because the user 18 is standing with the authenticated third party. As such, the user device 28 may present a bar code or other indicia such that the authenticated third party may scan or otherwise read the indicia. In this way, the transfer may take place despite the user 18 not being able to fully authenticate.

As a second example, a user 18 having an intermediate credential level may be permitted to transfer the subject document 10 to an authenticated and remote third-party kiosk or application. As a third example, a user 18 having high credential level may be permitted to transfer the subject document 10 to a non-authenticated third party. In some embodiments of the invention, the digital wallet 20 utilizes a weighing test, when determining whether the amount of credential level versus the trustworthiness of the external party.

As discussed above, an exemplary field of use of the invention is in the field of tax preparation, specifically the storing and transfer of tax-related documents. It should be appreciated that some embodiments of the invention are utilized by a tax return preparation program (such as an at-home tax preparation program or a professional tax preparation program). Other embodiments may be ancillary or secondary functions associated with a tax preparation program. A set of taxpayer information may additionally or alternatively be received. The set of taxpayer information may include additional known information about the taxpayer, such as account information, previous year tax returns, qualitative information, quantitative information, or other information known about the taxpayer. The image may also be received with, or as a component of, the set of taxpayer information. Other embodiments of the invention are or are associated with a financial transaction wallet, a financial services application, a banking application, or other application configured to be used by the user 18 as a digital wallet 20.

It should be appreciated that in embodiments of the invention, the discussed steps may be performed before or during completion of the tax return, upon the user 18 reaching a certain step in the completion of the tax return, upon specific request of the user 18, as a premium feature available to the user 18, or at another time. For example, the below discussed steps may be performed while the taxpayer or other user 18 is providing information to a tax return preparation program. The steps may be performed periodically such that the steps may be performed more than once during the preparation of the tax return. Successive iterations of the steps may include updated and additional information that is received later from the user 18.

The taxpayer may include any entity, either a legal or natural person, that files a tax return with a government taxing authority. The taxpayer may also be a married couple or other plurality of individuals filing a single tax return. Taxes to be paid can be United States Federal Income Tax, income tax for the various states within the United States, corporate taxes, partnership taxes, LLC taxes, property taxes, tariffs, or other taxes. Typically, the taxpayer provides information relevant to themselves and the amount of tax owed in the form of the tax return (based upon incomes, expenses, and the like). The tax return may therefore include information indicative of the employer and other external entities to which the taxpayer is or may be associated. The tax return may also include information indicative of various benefits that the taxpayer is utilizing (or has utilized during the tax year).

Tax return preparation may take place in any of various methods. In one embodiment, the taxpayer brings physical copies of his tax-related documents, such as W2s and 1099s, to the tax preparer. A tax preparer then enters information from the tax-related documents into a tax preparation computer program. In another embodiment, the taxpayer enters information from the tax-related documents into tax preparation software. The tax preparation computer program may be the same as or interface with the computer program of embodiments of the invention. In addition, the taxpayer answers questions related to his taxes, either verbally to the tax preparer or by inputting into the computer program.

The tax return is essentially a report filed with the appropriate government taxing authority, such as the Internal Revenue Service in the case of U.S. federal income tax. Typically, the tax return contains information used to calculate the tax due. Typically, the tax return is either printed or hand-written on a form generated by the taxing authority, such as the Form 1060. However, the tax return could be on another type of form, a financial document, or other document. On the tax return, the taxpayer or tax preparer calculates the taxes due. To assist in the calculation and to allow the taxing authority to verify the calculations, the tax return contains pertinent information associated with the taxpayer for the tax year. The tax return can be either written, digital, or a combination of both. In other embodiments, information relevant to the taxpayer and the tax to be paid are provided on other various forms and documents, such as a Form W2 or a Form 1099.

In this field of use, the tax documents are stored and transferred, based upon the tax implications of the documents. Implications are programs, code sections, benefits, and other aspects of the tax code that change a tax liability for the taxpayer. Implications may also originate in regulations, rulings, administrative agencies, and entitlement programs. For example, implications may include income sources, tax deductions, and tax credits. More specific examples of deductions include trade and business deductions, losses from sale or exchange of property, deductions from rents and royalties, pensions and annuities, retirement savings, alimony, moving expenses, interest on educational loans, higher education expenses, health savings accounts, startup expenses, expenses for determining tax owed, management of rental properties, charitable donations, medical care, various types of interest, depreciation, creation of a corporation, losses in a business or trade, business meals, entertainment related to business, trade and business education, state and local taxes. More specific examples of tax credits include taxes withheld, earned income tax credit (both of which are refundable credits), dependent care credits, child credits, Individual Retirement Account (IRA) contributions, and education expenses such as the Hope Scholarship and the Lifetime Learning Credit. Other implications may also be allowed by law, regulation, rulings, or other origin.

As a general rule, tax is due on “all income from whatever source derived, unless excluded by law” 1.61-1(a) of the U.S. Tax Code. Therefore, the taxpayer may reduce their tax burden by claiming various exclusions from all income that are allowed by law. Examples of these exclusions from income include compensation for certain services, certain gross income from business, certain gains from dealings in property, certain interest, certain rents, certain royalties, certain dividends, certain alimony and other spousal maintenance, certain annuities, income from life insurance, pensions, income from discharge of indebtedness, partnership income, income from a decedent, and interest in an estate or trust.

Deductions reduce the amount of taxable income based upon a certain type of expense or expenditure. Deductions may be based upon expenses incurred to produce additional income, for a charitable purpose, losses, and the like. Tax deductions can be classified into those above the line, which are beneficial to the taxpayer regardless of income, and below the line, which are only valuable to the extent that they exceed the standard deduction amount of the taxpayer. Examples of deductions are presented above.

In embodiments of the invention, a self-preparation tax return product utilizes the invention, such as the external entity and/or the digital wallet 20. For example, if the taxpayer uses a self-preparation tax return product, such as tax preparation software, embodiments of the invention provide a service to the taxpayer in conjunction with using the tax preparation software. The service may be provided to the user 18 as a value-added benefit to the tax preparation software or as a pay service.

In embodiments of the invention, the invention is utilized by a tax professional. In these embodiments that are used by the tax professional, the tax professional may use the service in conjunction with preparation and filing of the tax return. The tax professional includes any entity, either a legal person or natural person, or a computer program adapted to preparing taxes or providing other financial services. Examples of tax professionals include, but are not limited to, the following: a company, such as H&R Block, Inc.®, or an employee or agent of such a company; software adapted to prepare tax returns or other financial documents; and a person, legal or natural, who advises or assists the taxpayer in preparing their own tax return.

In other embodiments of the invention, the invention is utilized by a charitable organization, a for-profit company, a non-profit company, or other organization. In these embodiments, the organization may use or provide the services in conjunction with record keeping, an economic transaction to the be performed, or for another purpose. Embodiments utilized by the organization may be a free or pay service provided by the organization to clients to help the client in easily maximizing their deductions, incentivizing the usage of the particular organization, to keep records for the organization, to allow the organization to make informed business decisions, or for other business or charitable purposes.

In still other embodiments of the invention, the invention is utilized by a taxing authority. The taxing authority (also known as a revenue service or revenue agency) is a government entity or an entity associated with a government body. The taxing authority has, through prescribed legal authority, the power to assess, levy, and collect taxes. The taxing authority may also have the power to collect other non-tax-related revenue, such as penalties and interest. The taxing authority may perform secondary functions, such as investigating and charging tax fraud, performing audits, etc. The taxing authority can be at any level of government: international, federal, state, county, and city. Examples of taxing authorities include the IRS, the Missouri Department of Revenue, etc. The taxing authority may be motivated to utilize the invention to provide a benefit that could only be available in electronic form, thereby encouraging electronic filing which is easier and cheaper to receive than paper tax returns.

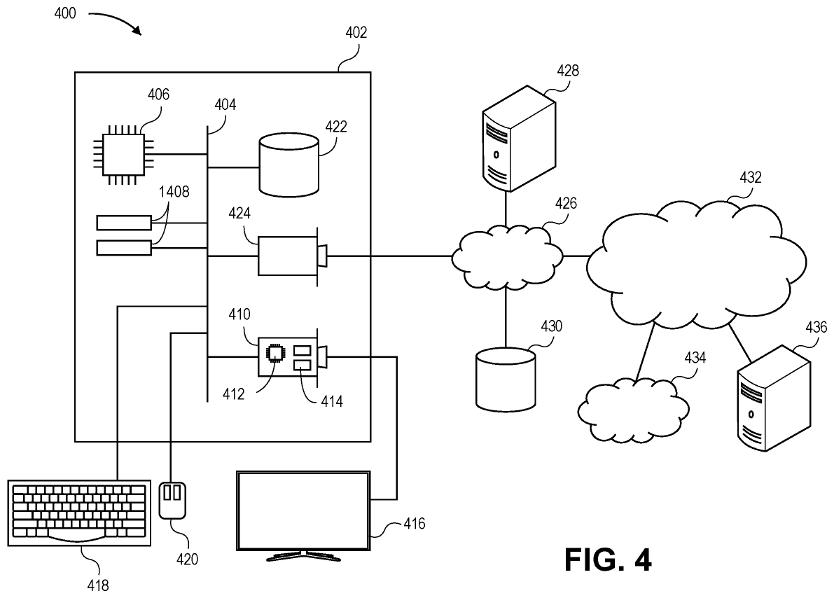

Turning to FIG. 4, the specific components of the system will now be discussed. An exemplary hardware platform for certain embodiments of the invention is depicted. Computer 402 can be a desktop computer, a laptop computer, a server computer, a mobile device such as a smartphone or tablet, or any other form factor of general- or special-purpose computing device. Depicted with computer 402 are several components, for illustrative purposes. In some embodiments, certain components may be arranged differently or absent. Additional components may also be present. Included in computer 402 is system bus 404, whereby other components of computer 402 can communicate with each other. In certain embodiments, there may be multiple busses or components may communicate with each other directly. Connected to system bus 404 is central processing unit (CPU) 406. Also attached to system bus 404 are one or more random-access memory (RAM) modules. Also attached to system bus 404 is graphics card 410. In some embodiments, graphics card 404 may not be a physically separate card, but rather may be integrated into the motherboard or the CPU 406. In some embodiments, graphics card 410 has a separate graphics-processing unit (GPU) 412, which can be used for graphics processing or for general purpose computing (GPGPU). Also on graphics card 410 is GPU memory 414. Connected (directly or indirectly) to graphics card 410 is display 416 for user interaction. In some embodiments no display is present, while in others it is integrated into computer 402. Similarly, peripherals such as keyboard 418 and mouse 420 are connected to system bus 404. Like display 416, these peripherals may be integrated into computer 402 or absent. Also connected to system bus 404 is local storage 422, which may be any form of computer-readable media, and may be internally installed in computer 402 or externally and removably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-usable instructions, data structures, program modules, and other data representations.

Finally, network interface card (NIC) 424 is also attached to system bus 404 and allows computer 402 to communicate over a network such as network 426. NIC 424 can be any form of network interface known in the art, such as Ethernet, ATM, fiber, Bluetooth, or Wi-Fi (i.e., the IEEE 802.11 family of standards). NIC 424 connects computer 402 to local network 426, which may also include one or more other computers, such as computer 428, and network storage, such as data store 430. Generally, a data store such as data store 430 may be any repository from which information can be stored and retrieved as needed. Examples of data stores include relational or object oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data sets stored therein such as backup or versioning. Data stores can be local to a single computer such as computer 428, accessible on a local network such as local network 426, or remotely accessible over Internet 432. Local network 426 is in turn connected to Internet 432, which connects many networks such as local network 426, remote network 434 or directly attached computers such as computer 436. In some embodiments, computer 402 can itself be directly connected to Internet 432.

The system may comprise computing devices to facilitate the functions and features described herein. The computing devices may comprise any number and combination of processors, controllers, integrated circuits, programmable logic devices, or other data and signal processing devices for carrying out the functions described herein, and may additionally comprise one or more memory storage devices, transmitters, receivers, and/or communication busses for communicating with the various devices of the system.

The computer program of embodiments of the invention comprises a plurality of code segments executable by the computing device for performing the steps of various methods of the invention. The steps of the method may be performed in the order discussed, or they may be performed in a different order, unless otherwise expressly stated. Furthermore, some steps may be performed concurrently as opposed to sequentially. Also, some steps may be optional. The computer program may also execute additional steps not described herein. The computer program, system, and method of embodiments of the invention may be implemented in hardware, software, firmware, or combinations thereof using the system, which broadly comprises server devices, computing devices, and a communication network.

The computer program of embodiments of the invention may be responsive to user input. As defined herein user input may be received from a variety of computing devices including but not limited to the following: desktops, laptops, calculators, telephones, smartphones, or tablets. The computing devices may receive user input from a variety of sources including but not limited to the following: keyboards, keypads, mice, trackpads, trackballs, pen-input devices, printers, scanners, facsimile, touchscreens, network transmissions, verbal/vocal commands, gestures, button presses or the like.

The server devices and computing devices may include any device, component, or equipment with at least one processing element and at least one memory element. The processing element may implement operating systems, and may be capable of executing the computer program, which is also generally known as instructions, commands, software code, executables, applications (“apps”), and the like. The at least one processing element may comprise processors, microprocessors, microcontrollers, field programmable gate arrays, and the like, or combinations thereof. The at least one memory element may be capable of storing or retaining the computer program and may also store data, typically binary data, including text, databases, graphics, audio, video, combinations thereof, and the like. The at least one memory element may also be known as a “computer-readable storage medium” and may include random access memory (RAM), read only memory (ROM), flash drive memory, floppy disks, hard disk drives, optical storage media such as compact discs (CDs or CDROMs), digital video disc (DVD), and the like, or combinations thereof. In addition to the at least one memory element, the server devices may further include file stores comprising a plurality of hard disk drives, network attached storage, or a separate storage network.

The computing devices may specifically include mobile communication devices (including wireless devices), work stations, desktop computers, laptop computers, palmtop computers, tablet computers, portable digital assistants (PDA), smart phones, and the like, or combinations thereof. Various embodiments of the computing device may also include voice communication devices, such as cell phones and/or smart phones. In preferred embodiments, the computing device will have an electronic display operable to display visual graphics, images, text, etc. In certain embodiments, the computer program facilitates interaction and communication through a graphical user interface (GUI) that is displayed via the electronic display. The GUI enables the user to interact with the electronic display by touching or pointing at display areas to provide information to the system.

The communication network may be wired or wireless and may include servers, routers, switches, wireless receivers and transmitters, and the like, as well as electrically conductive cables or optical cables. The communication network may also include local, metro, or wide area networks, as well as the Internet, or other cloud networks. Furthermore, the communication network may include cellular or mobile phone networks, as well as landline phone networks, public switched telephone networks, fiber optic networks, or the like.

The computer program may run on computing devices or, alternatively, may run on one or more server devices. In certain embodiments of the invention, the computer program may be embodied in a stand-alone computer program (i.e., an “app”) downloaded on a user's computing device or in a web-accessible program that is accessible by the user's computing device via the communication network. As used herein, the stand-along computer program or web-accessible program provides users with access to an electronic resource from which the users can interact with various embodiments of the invention.

In embodiments of the invention, users may be provided with different types of accounts. Each type of user account may provide their respective users with unique roles, capabilities, and permissions with respect to implementing embodiments of the invention. For instance, the user may be provided with a user account allowing access to the digital wallet 20, and allow for the accessing and transfer of documents therein. In addition, any number and/or any specific types of account are provided to carry out the functions, features, and/or implementations of the invention. Upon the user logging in to the electronic resource for a first time, they may be required to provide various pieces of identification information to create their respective accounts. Such identification information may include, for instance, personal name, business name, email address, phone number, or the like. Upon providing the identification information, the taxpayer, external entity, and/or tax preparer may be required to enter (or may be given) a username and password, which will be required to access the electronic resource.

Although embodiments of the invention have been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A digital wallet system comprising:
a document originator server configured to—
generate a subject document including a first portion;
associate an authentication stamp to form a document package; and
send the document package to a user; and
a user device corresponding to the user configured to—
receive the document package;
store the document package in a digital wallet;
receive, from the user, a request to access the subject document;
receive, from the user, a credential indication; and
provide, to the user, access to only said first portion of the subject document based upon a credential level of the credential indication.

2. The digital wallet system of claim 1, wherein said first portion is metadata about the subject document.

3. The digital wallet system of claim 1, wherein said first portion is a specific filled field on the subject document.

4. The digital wallet system of claim 1, wherein said first portion is of a lower sensitivity level than a remainder of the subject document.

5. The digital wallet system of claim 1, wherein the document originator server is further configured to—
receive an authentication request from a third party;
compare a key to the authentication stamp; and
send an authentication message to the third party upon a determination that the key is indicative of authenticity.

6. The digital wallet system of claim 1,
wherein said credential indication is a first credential indication,
wherein the user device is further configured to—
receive a second credential indication,
wherein the second credential indication is indicative of a higher credential level than the first credential indication; and
provide, to the user, access to an entirety of the subject document.

7. The digital wallet system of claim 6, wherein the user device is further configured to—
request, from the user, the second credential indication,
wherein the second credential indication is of a type selected based upon a credential level required to provide the requested access to the subject document.

8. The digital wallet system of claim 1,
wherein said credential indication is a first credential indication,
wherein the user device is further configured to—
receive, from the user, a request to transfer the subject document to a third party;
request, from the user, a second credential indication,
wherein the second credential indication is indicative of a higher credential level than the first credential indication; and
transferring the subject document to the third party.

9. A non-transitory computer readable storage medium having a computer programmed stored thereon for providing access to documents on a digital wallet, wherein upon execution by at least one processing element, instructs at least one processing element to perform the following steps:
receiving a document package,
wherein the document package includes a subject document having a first portion and an authentication stamp;
storing the document package in the digital wallet;
receiving, from a user, a request to access the subject document;
receiving, from the user, a credential indication; and
providing, to the user, access to only said first portion of the subject document based upon a credential level of the credential indication.

10. The non-transitory computer readable storage medium of claim 9, wherein said first portion is metadata about the subject document.

11. The non-transitory computer readable storage medium of claim 9, wherein said first portion is a specific filled field on the subject document.

12. The non-transitory computer readable storage medium of claim 9, wherein said first portion is of a lower sensitivity level than a remainder of the subject document.

13. The non-transitory computer readable storage medium of claim 9,
wherein said credential indication is a first credential indication,
further comprising the following steps:
receiving a second credential indication,
wherein the second credential indication is indicative of a higher credential level than the first credential indication; and
providing, to the user, access to an entirety of the subject document,
wherein said access includes presenting the entire document on a user device.

14. The non-transitory computer readable storage medium of claim 13, further comprising the following steps:
requesting, from the user, the second credential indication,
wherein the second credential indication is of a type selected based upon a credential level required to provide the requested access to the subject document,
wherein said request to access the subject document was is indicative of the credential level required.

15. The non-transitory computer readable storage medium of claim 9,
wherein said credential indication is a first credential indication,
further comprising the following steps:
receiving, from the user, a request to transfer the subject document to a third party;
requesting, from the user, a second credential indication,
wherein the second credential indication is indicative of a higher credential level than the first credential indication; and
transferring the subject document to the third party.

16. A computerized method of managing sensitive documents in a digital wallet, the method comprising the following steps:
receiving a document package,
wherein the document package includes a subject document having a first portion and an authentication stamp;
storing the document package in the digital wallet;
receiving, from a user, a request to access the subject document;
receiving, from the user, a credential indication; and
providing, to the user, access to only said first portion of the subject document based upon a credential level of the credential indication.

17. The computerized method of claim 16, wherein said first portion is of a lower sensitivity level than a remainder of the subject document.

18. The computerized method of claim 16,
wherein said credential indication is a first credential indication,
further comprising the following steps:
receiving a second credential indication,
wherein the second credential indication is indicative of a higher credential level than the first credential indication; and
providing, to the user, access to an entirety of the subject document,
wherein said access includes presenting the entire document on a user device.

19. The computerized method of claim 18, further comprising the following steps:
requesting, from the user, the second credential indication,
wherein the second credential indication is of a type selected based upon a credential level required to provide the requested access to the subject document,
wherein said request to access the subject document was is indicative of the credential level required.

20. The computerized method of claim 16,
wherein said credential indication is a first credential indication,
further comprising the following steps:
receiving, from the user, a request to transfer the subject document to a third party;
requesting, from the user, a second credential indication,
wherein the second credential indication is indicative of a higher credential level than the first credential indication; and
transferring the subject document to the third party.
